(19) United States
(12) Patent Application Publication
(10) Pub. No.: US 2024/0401205 A1
(43) Pub. Date: Dec. 5, 2024

(54) LASER CLADDING METHOD FOR PRODUCTION OF COATING LAYERS ON MUTUALLY OPPOSITE SURFACES OF A COMPONENT

(71) Applicant: TRUMPF Laser- und Systemtechnik GmbH, Ditzingen (DE)

(72) Inventors: Tim Hesse, Ditzingen (DE); Andreas Scholz, Taunusstein (DE); Nicolai Speker, Pleidelsheim (DE); Bjoern Sautter, Leonberg (DE)

(21) Appl. No.: 18/798,856

(22) Filed: Aug. 9, 2024

Related U.S. Application Data
(63) Continuation of application No. PCT/EP2023/052520, filed on Feb. 2, 2023.

(30) Foreign Application Priority Data
Feb. 11, 2022 (DE) 10 2022 103 277.9

(51) Int. Cl. C23C 24/08

(52) U.S. Cl. CPC C23C 24/085

(57) ABSTRACT

A laser cladding method includes directing a filler material in a pulverulent form along a respective working trajectory onto each respective surface of two mutually opposite surfaces of a component, and heating the filler material and the component by directing a respective laser beam along the respective working trajectory so that the filler material binds to the component as the filler material meets the respective surface, thereby producing coating layers on the two mutually opposite surfaces at least partly at a same time.

### CROSS REFERENCE TO RELATED APPLICATIONS

This application is a continuation of International Application No. PCT/EP2023/052520 (WO 2023/152014 A1), filed on Feb. 2, 2023, and claims benefit to German Patent Application No. DE 10 2022 103 277.9, filed on Feb. 11, 2022. The aforementioned applications are hereby incorporated by reference herein.

### FIELD

Embodiments of the present invention relate to a laser cladding method for production of coating layers on mutually opposite surfaces of a component, to an apparatus for execution of the laser cladding method and to a component having mutually opposite surfaces coated with coating layers, wherein the coating layers have been produced by the laser cladding method.

### BACKGROUND

Conventional laser cladding is well known from the prior art. This involves melting a surface of a component by means of a laser beam and supplying the melt bath formed with a pulverulent filler material. The powder is then likewise melted in the melt bath, such that, after solidification of the molten powder material and the surface, a cohesively bonded, especially metallurgically bonded, material layer is formed.

This operation, depending on the application, can be conducted at different points on the surface or else over a larger coherent region of the workpiece surface, which allows 3D shapes to be applied by laser cladding. In addition, it is also possible to build up multiple material layers of different materials one on top of another on the surface. If metallic material is being applied, the cladding method is also referred to as laser metal deposition (LMD for short). Typical fields of use for laser cladding can be found in the field of repair, coating and bonding techniques.

What is called extreme high-speed laser application (EHLA) is already known from DE 10 2011 100 456 B4. By this method, a significant increase in achievable machining speed compared to conventional laser cladding is achieved in that a laser-filler material interactions zone present on a surface to be processed, especially an at least partial melt bath, is supplied with at least one filler material in fully molten form. For this purpose, the filler material, which is at first especially in pulverulent form, is melted by means of a laser beam at a distance from the melt bath of greater than zero and then fed to the melt bath in completely liquid form. It is possible here for the filler material, especially the powder, to be melted at the stated distance from the melt bath and for the melt bath to be heated by the same laser beam. The laser beam incident on the melt bath thus also causes the filler material to melt at the stated distance from the melt bath. This is accomplished by moving the melt bath and a focus of the laser beam parallel to one another relative to the surface at a speed of at least 20 m/min. Furthermore, in the case of a pulverulent filler material, the powder density can be set in particular such that a laser power output of the laser beam in the melt bath is less than 60% of the laser power output before the laser beam makes contact with the powder. It is thus possible by means of the EHLA method to significantly increase the processing speed of the laser cladding operation.

In some applications, the coating is effected on opposite surfaces or sides of the component. A known method for this purpose is to turn the component over after the coating on one surface and then to coat the other surface. Accordingly, the component in the prior art is coated on one side in each case.

Especially in the case of use of high laser power outputs of, for example, more than 4 kW, the components can bend under the thermal energy input in laser material processing. The person skilled in the art refers here to doming (the origin of the word is that the shape of a warped component, for example of a warped brake disk, if viewed from the side, has the dome shape of an umbrella). In addition, material shrinkage in the course of solidification and cooling of the coating produced in the prior art by high-speed laser metal deposition in particular (HS-LMD for short) gives rise to tensile stresses on the component surface. This gives rise to a high proportion of component warpage, called doming. This doming results in nonuniform layer thicknesses, or in some cases deposition welding of a very large amount of material is necessary in order again to obtain a plane-parallel component to scale after grinding (called surface finishing) of the component.

### SUMMARY

Embodiments of the present invention provide a laser cladding method. The laser cladding method includes directing a filler material in a pulverulent form along a respective working trajectory onto each respective surface of two mutually opposite surfaces of a component, and heating the filler material and the component by directing a respective laser beam along the respective working trajectory so that the filler material binds to the component as the filler material meets the respective surface, thereby producing coating layers on the two mutually opposite surfaces at least partly at a same time.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a setup of an apparatus for laser cladding according to some embodiments;

FIG. 2 is a top view of a component in one working example;

FIGS. 3a and 3b are schematic views of a laser cladding method according to some embodiments;

FIG. 4 is a schematic view of a laser cladding method in a first working example according to some embodiments;

FIG. 5 is a schematic view of a laser cladding method in a second working example according to some embodiments; and

FIGS. 6, 7 and 8 are schematic views of different arrangements of laser processing heads relative to the component to be coated according to some embodiments.

### DETAILED DESCRIPTION

Embodiments of the invention can reduce the above disadvantages in a laser cladding method, and to improve the component quality produced.

According to some embodiments, a laser cladding method is provided for production of coating layers on mutually opposite surfaces of a component by directing a filler material, especially in pulverulent form, along a working trajectory, especially in spiral form, onto each of the respective surfaces, wherein the filler material and the component are heated by a laser beam along the working trajectory such that the filler material binds to the component (to the respective coating layer or at least part thereof on the respective surface) where it meets the respective surface. The coating layers on the opposite surfaces are produced here at least partly at the same time.

By means of simultaneous processing of the component on both sides in accordance with embodiments of the invention, it has been found that doming can be effectively avoided or at least reduced. It is thus firstly possible to provide symmetric thermal stress on the component, which means that thermal warpage, which results in doming, during processing can be reduced. Symmetric tensile stresses are also generated on both surfaces or sides of the component.

An additional advantage is that the cycle time of the production of the coating layers can advantageously also be reduced. This is because the cycle time for the production of the two coatings on the opposite surfaces of the component is comparatively long in the prior art owing to single-sided processing. Additional time is also required to turn the component round and clamp it again. In order to shorten the cycle time, several apparatuses for laser cladding can be utilized, such that several components can be single-sidedly coated in parallel. However, the plant costs for the maintenance of multiple devices for laser cladding are correspondingly high. According to embodiments of the invention, the simultaneous processing of the two surfaces of the component permits more than halving of the cycle time, since not only is it possible to produce the two coating layers completely simultaneously, but reclamping of the component is also dispensed with. It is equally possible, with use of the same laser power output per disk side, likewise to halve the necessary number of devices.

What is meant here by at least partly simultaneous production is that simultaneous production has to be effected at least over a particular minimum time span. For example, the minimum time span may be at least half or at least three quarters of the necessary production time for production of a coating layer on one of the surfaces. The reason for this is that, because of the inertia in the heat transfer of the component, it is not absolutely necessary for there to be simultaneous production of the coating layers at any juncture. Nevertheless, it is naturally preferable when the coating layers on both surfaces of the component are produced essentially completely simultaneously, i.e. the coating is commenced and ended at the same juncture in order to achieve the shortest cycle time.

It may especially be envisaged that, in the laser cladding method, a laser-filler material interaction zone on the surface of the component, especially an at least partial melt bath, is produced with at least one at least partly molten filler material by means of a laser beam incident on the laser-filler material interaction zone. It is possible here for the at least one filler material already to be melted on the surface of the component by means of the respective laser beam at a distance from the respective laser-filler material interaction zone, such that the at least one filler material is supplied to the respective laser-filler material interaction zone in at least partly molten form. In this respect, in particular, a further laser-filler material interaction zone already exists at a distance from the surface of the component, in which the pulverulent filler material in particular is melted and meets the surface of the component. In this respect, this description also distinguishes between the laser-filler material interactions zones on the opposite surfaces of the component and the further laser-filler material interaction zones at a distance from the surfaces of the component.

It may be the case that points of incidence of the laser beams on the surfaces are moved along the working trajectory or the surfaces each with a relative speed of at least 20 m/min. The relative speed is that speed with which the surface to be coated is moved relative to the point of incidence of the laser beam on the surface. The laser beam is incident on the surface such that a laser-filler material interaction zone, especially an at least partial melt bath, is formed on the surface. Consequently, one could also say that the point of incidence and hence the laser-filler material interaction zone are moved across the surface at a speed of at least 20 m/min. The advantage of this high relative speed is that the component is heated very substantially uniformly over its circumference, such that no significant local thermal warpage arises on the circumference of the component.

It may further be the case that the component is in rotationally symmetric form, especially in disk form, and in particular is rotated about an axis of rotation during the production of the coating layers. The component may, for example, be a brake disk, slide disk, friction disk or the like, as may occur in various applications, for example in motor vehicles. The surfaces to be coated may each be circular ring-shaped surfaces. Accordingly, rotation of the disk about its axis of rotation permits circumferential coating of the disk. For this purpose, the disk may be secured on a shaft of a corresponding drive, for example of an electric motor, that sets the disk in rotation. Aside from this, the points of incidence of the laser beams can be shifted, especially in a linear movement. In particular, these can be shifted in a plane across the disk. This can be effected, for example, by means of a linear drive at processing heads that emit the laser beams. The alignment of the feed of the at least one filler material can also be moved in each case together with the points of incidence of the laser beams.

It may further be the case that the at least one filler material is in powder form before being melted by means of the laser beams. The filler material may be metallic. As well as a metallic filler material, other materials that are to be incorporated into the coating layer may also be present. In addition, it is also possible to process different metals. Alternatively, it is conceivable that the filler material is in the form of a wire, tape or sheet metal strip. However, supply of pulverulent filler material to the laser beam for melting, such that it is supplied to the melt bath in fully molten form in particular, has been found to be advantageous.

In addition, it may be the case that the at least one filler material is provided for the respective laser beam by at least three injectors for each surface of the component. Preferably, there are in particular 3 to 21 injectors, in particular 7 to 14 injectors, per surface or side of the component. As a result, it is possible to create a very symmetric focus of the filler material, especially powder focus, on the surface, which can improve the quality of the coating layer generated.

Moreover, it may be the case that an average powder efficiency with pulverulent filler material from all injectors together is at least 85%. Powder efficiency indicates how much of the powder supplied is melted. Loss of powder can thus be reduced. One means by which this can be enabled is the use of injectors that can be used in the angle range around 90° to the direction of gravity.

Moreover, it may be the case that the injectors are supplied with powder from a corresponding powder conveyor by two or more feed conduits that can be directed via a distributor component into two or more clusters by the injectors. The necessary powder mass flow rate can thus be divided between parallel powder feed strands. This achieves a uniform powder mass flow rate, and hence uniform coating layers are created.

The injectors may advantageously take the form of tubes. In particular, they may take the form of cemented carbide tubes in order to have high resistance firstly to the filler material and secondly to the high temperatures that emanate from the laser-filler material interaction zones. The benefit of tubes lies additionally in a good flow of a possible conveying gas through them, in order to supply the filler material from a corresponding conveyor or reservoir to the laser beams at a distance from the surfaces.

In addition, it may be the case that an exit angle of the injectors with respect to a normal to the respective surface of the component is less than 60°, less than 50°, or less than 40°. It has been found that surface corrugation of the coating layers that have been welded on thereby is thus minor.

It may further be the case that the at least one filler material is supplied to the respective laser beam by means of a conveying gas, wherein the conveying gas especially has a relative atomic mass of at least 4, especially at least 14, and/or a specific volume flow rate of at least 3.21 (STP)/min per mm² of cross-sectional area. It has been found that the conveying gas with the above parameters provides sufficiently strong momentum and hence a sufficiently high filler material velocity, especially powder velocity, that the filler material can be guided to the laser beam without any significant influence by external factors, for example the gravity acting on the filler material, and hence in an optimal manner.

It may also be the case that the coating layers of the component are produced in the direction from the relative inside of the surfaces to the relative outside of the surfaces. In the case of a disk as component, the coating or the method of laser beam points thus proceeds from the radial inside or the internal diameter to the radial outside or the external diameter. In this way, it is possible to use thermal expansion to create tensile stresses in the component, especially the disk. On cooling, compressive stresses are formed in the coating layers that have been welded on. These are advantageous since compressive stresses counteract progression of cracks in the coating layers that have been welded on.

Moreover, it may be the case that laser beam axes of the laser beams are inclined at an angle of incidence in the range from greater than 0° to 35°, especially in the range from 5° to 30°, relative to the surfaces. For this purpose, a principal axis of processing heads from which the laser beams are emitted may be correspondingly inclined with respect to the surfaces. Laser light reflected back by the component at the angle of incidence thus does not hit the processing head, but is deflected past it.

In addition, it may be the case that the laser power output of a laser beam directed onto one of the surfaces is at least twice as high as the laser power output of the laser beam directed onto the other of the two surfaces. In particular, it may be the case that the laser power output of a laser beam is not more than 30% greater than that of the other laser beam. It is advantageous when the laser power outputs of the laser beams are essentially the same. As a result, it is likewise possible to ensure high thermal symmetry between the two surfaces or sides of the component. Doming of a disk as component can thus likewise be effectively avoided. Any need for grinding in the case of further processing of the disk to counteract doming can thus be reduced.

It may also be the case that the two laser beams are collectively moved relative to the component by a common advancing unit. The implementation of a common advancing unit that can connect the two processing heads of the laser beams by means of a carrier element means that just one actuator is required for the linear movement of the points of incidence. The advance rate-to-advance distance profile of the two laser beams thus also mutually corresponds.

It may also be the case that the two laser beams are moved with respectively different advance rate-to-distance profiles and/or different amounts of the filler material are fed to each surface, wherein this creates different layer thicknesses of the coating layers on the opposite surfaces of the component. This makes it possible to again straighten an already domed component, especially a domed disk, by means of layers of different thickness.

It may alternatively be the case that the two laser beams are moved with respectively different advance rate-to-distance profiles, wherein the different advance rate-to-advance distance profiles are mutually complementary. For this purpose, the two processing heads of the different laser beam may also be equipped with separate advance units, i.e. linear drives, per surface. Thus, a laser beam may have an advance rate-to-advance distance profile that drops over the path traversed in advance direction, while the other laser beam has an advance rate-to-advance distance profile that rises over the path traversed in advance direction. The slopes of the different profiles may be of the same magnitude. Thus, wedge-shaped coating layers are produced in cross section through the component that have mutually opposite wedge-shaped alignments. What is advantageous about the use of such different advance rate-to-advance distance profiles is that doming of the component that already exists or has been generated can be compensated for. Advantageously, the coating layers can additionally be built up in multiple layers, i.e. in particular by repeated laser cladding, in order to form coating layers of maximum homogeneity in terms of their thickness, which have maximum service life in the working example of the brake disk for utilization.

It is also possible that the intensity distributions of the laser beams are created at least approximately in the form of a “flat top”. By comparison with a Gaussian laser output power distribution, it has been found that lower roughnesses are thus created in the coating layers. It is possible for the intensity distributions to be approximately in the shape of a flat top with a region of lower intensity in the center (I_max (maximum intensity)≥I_core (intensity in the core)≥0). This opens up large process windows for a laser cladding operation. This means that the application of power output to the two surfaces may be adjusted in a thermally sufficiently symmetric manner for the coating.

Moreover, it may be the case that a sensor device, such as a camera, especially a VIS camera or IR camera, or such as a pyrometer, may be arranged oriented in a coaxial measurement direction or viewing direction relative to the laser beam. This enables real-time observation of the process procedure in the course of coating. The coating process can thus be conducted in a closed-loop control circuit of a corresponding closed-loop control device.

It may further be the case that the laser beam axes of the laser beams are run congruently with respect to one another. The laser beam axes thus coincide (in their extension) in the processing operation. In other words, the points of incidence of the laser beams or, overall, the process zones of the coating with the melt baths may be in a mirror-symmetric arrangement with respect to the component plane. This permits a high degree of thermally symmetric processing of the component.

Alternatively, it may also be the case that the laser beam axes of the laser beams are run incongruently with respect to one another. The laser beam axes thus do not coincide in the processing operation. Instead, the points of incidence of the laser beams or the process zones are laterally offset from one another with respect to the linear movement of the laser beam axes. This has the advantage that the opposite processing heads cannot irradiate one another, which increases safety.

The object mentioned at the outset is additionally achieved by a component as claimed in claim 15. The component has mutually opposite surfaces that have been coated with coating layers, where the coating layers have been produced by a laser cladding method according to embodiments of the invention.

Features described herein in relation to the laser cladding method are likewise applicable in relation to the component and vice versa.

The object mentioned at the outset is also achieved by an apparatus as claimed in claim 16. The apparatus is set up to execute a laser cladding method according to embodiments of the invention, wherein the apparatus has at least one laser for generation of the laser beams, and wherein the apparatus has at least one filler material conveyor for conveying of the at least one filler material at a distance of the surfaces of the component from the laser beams, especially at a distance of the respective laser-filler material interaction zones, especially melt baths, on the surfaces of the component from the laser beams.

Features described herein in relation to the laser cladding method and the component are likewise applicable in relation to the apparatus, and vice versa in each case.

The at least one laser may preferably have a laser power output of more than 4 kW, especially more than 12 kW, and up to 24 kW. This may, for example, be a laser with a wavelength of about 1 μm (fiber laser, disk laser), about 0.8 μm (diode laser) or 0.5 μm (green-converted). It is possible to use a laser light cable with 2-in-1 fibers, where a core diameter of 600 μm to 1000 μm or diameter ratios of 200 μm/700 μm and 300 μm/1000 μm may be implemented. It is also possible to use an adjusting device (wedge beam switch) to adjust the core-shell ratio of the 2-in-1 fibers. A processing head of the laser, for imaging of the fiber end of the 2-in-1 fibers into the region of a powder focus or onto the surfaces, may have a focus of about 1.4 mm to about 8 mm.

The at least one filler material conveyor may take the form of a powder conveyor and have a powder nozzle to form a powder focus. The powder nozzle may, as has been described above, be executed by means of injectors, especially with several injectors as a multi-jet nozzle. The conveying gas utilized may, for example, be inert gas such as argon or helium or a gas mixture thereof. It is also possible to feed a protective process gas to the site of operation.

It is then possible to use one laser and one filler material conveyor in the apparatus for each surface of the component, such that essentially the entire structure of the apparatus with the aforementioned further periphery, for example linear drive, injectors etc., and with the exception of the drive for the rotation of the component, can be duplicated on the two sides of the component. Alternatively, it is possible to use a common laser and/or filler material conveyor for both surfaces or sides of the component in order to minimize the costs of the apparatus. For this purpose, the laser beam from the laser can be divided and directed onto both surfaces. It is also possible for the filler material conveyor to be designed to convey the filler material on both sides. However, at least one processing head is provided for each side or surface of the component, which in each case permits optical focusing of the laser beam onto the respective surface. Moreover, one powder feed is provided in each case, for example in the form of at least one injector each per surface. Moreover, a clamping device may be provided, by means of which the component can be clamped, especially vertically, between the two processing heads and especially also the injectors for processing. The clamping device may be provided as a component on the aforementioned shaft for rotation of a disk.

In the description that follows and in the figures, the same reference signs are used in each case for identical or corresponding features.

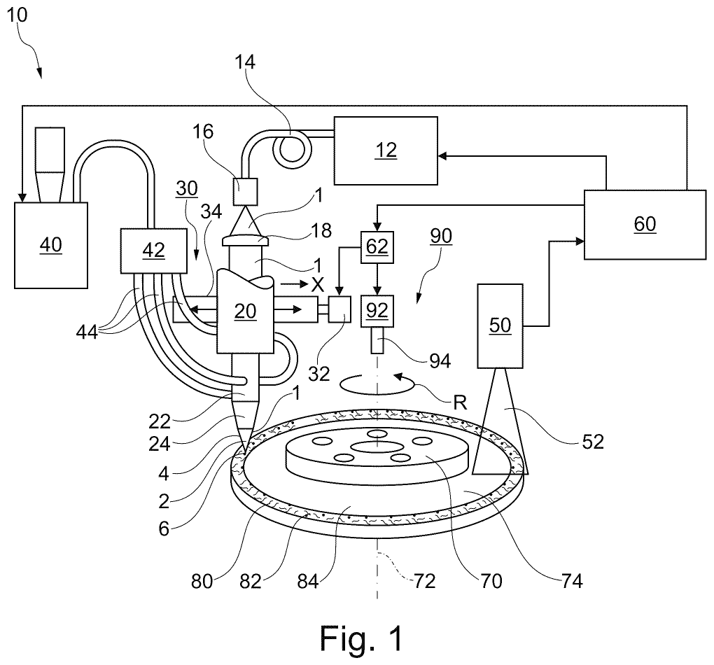

FIG. 1 shows, overall, an apparatus 10 for laser cladding. The apparatus 10 comprises a laser 12 for generation of a laser beam 1. The laser beam 1 generated is sent to a light exit 16 via an optical waveguide cable 14. The laser beam 1 thus directed is then collimated in a collimation lens 18. Thereafter, the laser beam 1 passes through a movable processing head 20 (incidentally, the light exit 16 and the collimation lens 18 may alternatively also be disposed in the processing head 20 itself). Within the processing head 20 is disposed a focusing lens (not shown) for focusing of the laser beam 1. After passing through the focusing lens, the laser beam 1 passes through a cylindrical section 22 and a funnel-shaped section 24 of the processing head 20, which also serve herein as a powder nozzle for a pulverulent filler material 2.

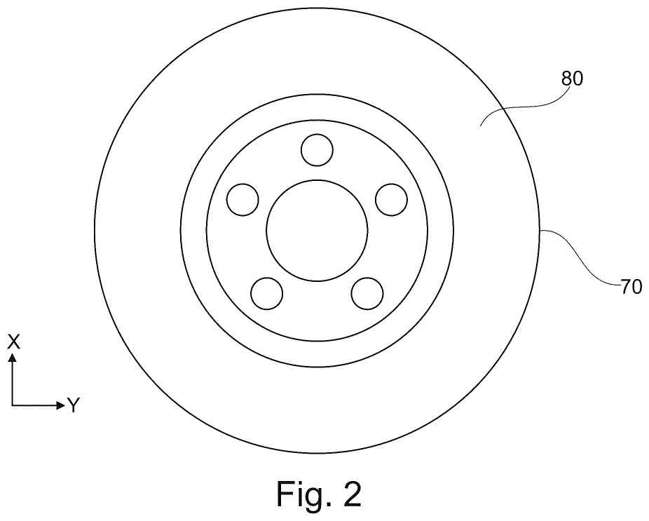

The whole assembly composed of light exit 16, collimation lens 18 and processing head 20 is arranged so as to be movable in a linear manner by means of an advancing unit 30 across a component 70 to be coated. To be exact, the advancing unit 30 can be moved in the plane formed by an X coordinate and Y coordinate across the component 70 (see FIG. 2). By way of example, the advancing unit 30 in the present context comprises a linear drive 34 and an electric motor 32 that drives the linear drive 34. Moreover, the apparatus 10 has a rotation unit 90 which, in the present context, has a further electric motor 92 with a shaft 94 coupled thereto for rotation of the component 70 mounted thereon. The component 70 is in rotationally symmetric form here by way of example, especially in the form of a brake disk, and is rotated about its axis of rotation 72, which coincides with the shaft 94, in the direction of rotation R shown in the course of coating of the component 70 with a coating layer 80 which will be elucidated in detail later on.

The apparatus 10 also comprises a filler material conveyor 40 for conveying of pulverulent filler material 2. In the filler material conveyor 40, the powder is admixed with a gas, especially an inert gas such as nitrogen or argon, in order to generate a powder gas stream 4 for conveying of the powder. A distributor component 42, the powder gas stream 4 is distributed into two or more, three by way of example in the present case, feed conduits 44, especially feed hoses, and then fed into the cylindrical section 22 of the processing head 20. The section 24 of the processing head 20 has a double wall, where the powder gas stream is conducted through the annular gap achieved thereby, such that the powder gas stream 4 flows through between the two walls. The laser beam 1 and the powder gas stream 4 consequently run coaxially through the sections 22 and 24. In the funnel-shaped section 24, the annular gap between the two walls narrows, such that the powder gas stream 4 departs via a nozzle-like outlet of the funnel-shaped section 24 that is formed thereby.

The apparatus 10 also comprises a sensory measurement device 50. The measurement device 50 may be set up, for example, for execution of the light section method, in order thus to create a height profile of the surface 74. It is possible here, for example, to conduct a light section scan at 4 kHz. In particular, a height profile may be generated here along a projected light line 52 shown in schematic form.

Finally, the apparatus 10 comprises a closed-loop control device 60. This serves firstly to control the laser 12 and the filler material conveyor 40. In addition, this serves to actuate a control unit 62 that likewise forms part of the apparatus 10, which is set up to actuate the electric motor 32 and the further electric motor 92. Moreover, the closed-loop control device 60 is set up to evaluate the measurement signals detected by the measurement device 50.

Overall, the apparatus 10 is set up to execute the method set out below:

The surface 74, which is circular ring-shaped in the present case, of the component 70 is coated by means of the apparatus 10 by extreme high-speed laser application (EHLA). For this purpose, the component 70 is first set in rotation in that the shaft 94 is driven by the further electric motor 92.

In addition, the laser beam 1 is generated and projected onto the surface 74, with incidence of the laser beam 1 on the surface 74 at a point of incidence. As a result, a laser-filler material interaction zone 6 is formed on the surface 74, in particular an at least partial melt bath. In addition, a powder gas stream 4 is generated. After departure from the cylindrical section 24, the pulverulent filler material 2 in the powder gas stream 4, during its phase in flight, meets the light pathway of the laser beam 1. The filler material 2 and the laser beam 1 may be directed on to the surface 74 along a working trajectory which is in spiral form in particular. For this purpose, the laser beams 1 and the filler material 2 and/or, as will be elucidated later on using the example of a rotation, the component 70 are moved relative to one another. The filler material 2 is consequently heated by means of the laser beam 1 along the working trajectory. As a result, the filler material 2 in the form of the powder particles is melted at least partly or completely before these reach the surface 74 of the component 70. As a result, the at least partly molten filler material, where it meets the surface 74 or the component 70, bonds to the component 70, such that a coating layer 80 is created. In particular, a further laser-filler material interaction zone (not labeled) exists at a distance from the surface 74 or the laser-filler material interaction zone 6 on the surface 74 (one could also say that the two interaction zones are associated with one another on the basis of their respective thermal effects, but for the sake of clarity these will be considered separately). In this further laser-filler material interaction zone, at a distance from the surface 74, there is already melting of the filler material 2 “in flight” to the surface 74, as already elucidated above. Thus, the filler material is supplied to the laser-filler material interaction zone 6 on the surface 74 in at least partly or completely molten form. At the same time, the component 70 is rotated about the axis of rotation 72 sufficiently quickly that the point of incidence of the laser beam 1 on the surface 74 is moved along the surface 74 at a speed of at least 20 m/min. As a result, the laser-filler material interaction zone 6 generated by means of the laser beam 1 on the surface 74 is moved along the surface 74 by at least 20 m/min.

As a result of the laser cladding operation, the aforementioned coating layer 80 is created gradually. For this purpose, the laser beam 1 is gradually moved from radially outward to radially inward relative to the axis of rotation 72 by means of the linear drive 34, such that the point of incidence of the laser beam 1 is moved along the surface 74 in a spiral-shaped working trajectory. Equally, the laser-filler material interaction zone 6 is consequently guided in a spiral on the surface 74 from radially outward to radially inward to create the coating layer 80. As apparent in FIG. 1, the surface 74 has a coated radially outer section 82 and an uncoated radially inner section 84.

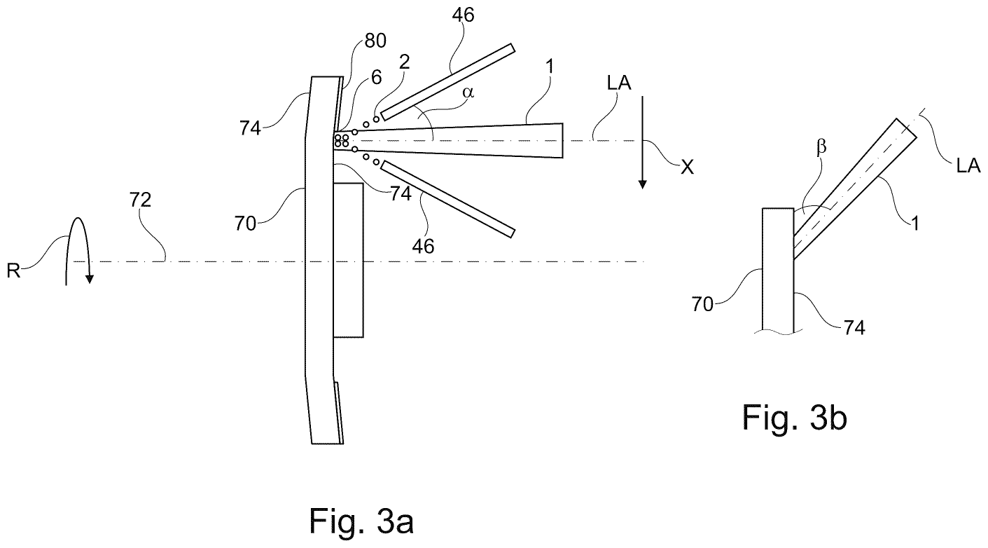

FIG. 2 shows the component 70 in the form of a brake disk for a motor vehicle, where the surface 74 has the coating layer 80 that has been produced by the method described above. Such a coating layer 80 is also created on the opposite surface 74 or side of the component 70. For this purpose, it is also known that the component 70 can be turned over and also single-sidedly coated on the other surface 74 by means of the apparatus 10 of FIG. 1. This can result in doming of the disk-shaped component 70, as can be seen, for example, in FIG. 3a. The cycle time for the production of the two coating layers 80 on the opposite surfaces 74 of the component 70 is also comparatively long since the coating layers 80 are each produced on one side. Additional time is also required to turn and clamp the component 70. In order to shorten the cycle time, several apparatuses 10 can be utilized, such that several components 70 can be processed in parallel. However, the plant costs for the maintenance of multiple apparatuses 10 are correspondingly high.

FIG. 3a shows the laser cladding method for the component 70 similarly to FIG. 1 in a schematic cross-sectional view. Unlike in FIG. 1, no processing head 20 is used, as described in relation to FIG. 1. Instead, two or more injectors 46 are used here, of which only two are shown here by way of example, by means of which the filler material 2 is fed directly to the laser beam 1, especially as a powder gas stream 4. The injectors 46 are shown here by way of example as tubes, especially cemented carbide tubes. They may each be bonded to the distributor component 42 by means of one, two or more feed conduits 44. It is also possible that each injector 46 has a dedicated distributor component 42, where the distributor components 42 may in turn be connected to the filler material conveyor 40. As can also be seen in FIG. 3a, the laser beam 1 with its laser beam axis LA is moved in the present case by way of example in X direction as the advance direction, which means that its point of incidence is also moved in that direction. In the case of rotation R of the component 70, this occurs about the axis of rotation 72.

In FIG. 3a, in addition, an exit angle α of the injectors 46, with respect to a normal to the respective surface 74, which coincides here by way of example with the longitudinal axis LA of the laser beams 1, is less than 60°. It has been found that surface corrugation of the coating layers 80 that have been welded on thereby is thus minor.

FIG. 3b shows a modification of the beam guidance of the laser beam 1, in which the laser beam axis LA of the laser beam 1 is at an advantageous angle of incidence β with respect to the surface 74, such that the laser beam 1 is incident on the surface 74 with its point of incidence at the angle of incidence β. The angle of incidence β here by way of example is 35°. The adjustment of the angle of incidence β can especially be achieved by appropriate arrangement of the processing head 20 relative to the surface 74, where the powder gas stream 4 can be conducted within the processing head 20, as shown in FIG. 1, or can be conducted outside the processing head 20, such that only the laser beam 1 is conducted within and exits from the processing head 20. Advantageously, a laser beam 1 hitting the surface 74 at the angle of incidence β cannot be reflected back to the processing head 20 as laser light, but is deflected past it.

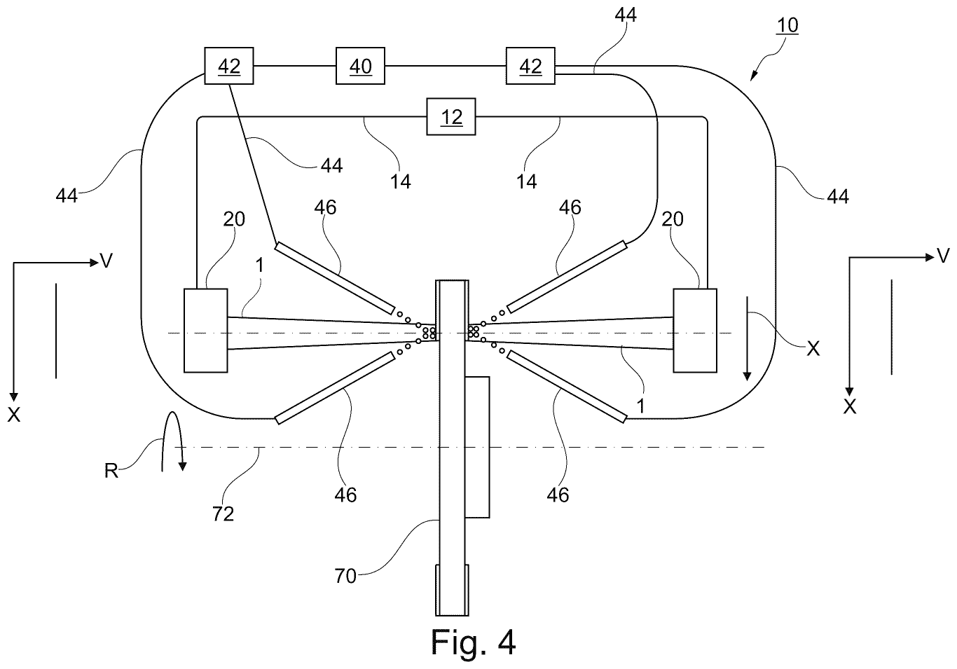

FIG. 4 shows an embodiment of the laser cladding method that has been modified with respect to FIG. 3, likewise showing a variant of the feeding of filler material 2 to the laser beam 1 with injectors 46 according to FIG. 3a, which can alternatively also be executed with the processing head 20 according to FIG. 1. Here too, the laser beam axis LA of the laser beam 1 can be directed relative to the surface 74 at the angle of incidence β of FIG. 3b. Overall, the various embodiments of FIGS. 1 to 8 that have been elucidated in detail here may be combined with one another as desired, to the extent that this is technically viable. For example, the setup of the apparatus 10 in FIG. 4, which has not been elucidated in detail, may include one, more than one, or all components of FIG. 1.

Unlike in FIGS. 1 and 3a, in the laser cladding method of FIG. 4, the producing of the coating layers 80 on the opposite surfaces 74 of the component 70 is conducted simultaneously. As shown by FIG. 4, for this purpose, laser beams 1 with corresponding feeding of the filler material 2 via injectors 46 are provided on both sides or surfaces 74. As a result, thermal stress and tensile stresses in the component 70 are distributed symmetrically over the opposite surfaces 74, as a result of which thermal warpage, which would otherwise lead to doming of the component 70, can be prevented or at least reduced.

By way of example, an apparatus 10 of FIG. 1 with mirror-image setup may be arranged opposite both surfaces 74. Alternatively, it is possible that individual components of such a mirror-image or duplicate setup of the apparatus 10 are shared, for example the laser 12, the laser beam 1 from which can be used for processing on both surfaces 74, or, for example, the filler material conveyor 40. This is indicated in FIG. 4, in which, for the sake of clarity, processing heads 20 are shown merely in schematic and individualized form on each side of the surfaces 74, which are connected to a common laser 12 via corresponding optical waveguide cables 14. As mentioned, this is merely a schematic illustration; it is of course also possible for there to be further components, as elucidated in detail in FIG. 1, for beamforming of the laser beam 1. Likewise shown here by way of example is a common filler material conveyor 40 with distributor components 42 for the injectors 46. By way of example, the injectors 46 are each connected to their respectively assigned distributor component 42 only via one feed conduit 44, although it is of course also possible here for two or more feed conduits 44 to be provided per injector 46.

Advantageously, in the working example of FIG. 4, it is also possible for a common advancing unit 30 to be provided for the two processing heads 20 (and also the injectors 46) for each surface 74, although this is not shown in FIG. 4. Advantageously, it is also possible, moreover, for just one closed-loop control device 60 to be provided in order to mutually match the simultaneous production of the coating layers 80 on the two surfaces 74, which is likewise not shown in FIG. 4.

As also illustrated by FIG. 4 by the diagrams alongside the respective laser beams 1, which show the advance rate in the advance direction with respect to the distance covered in advance direction X, i.e. each show an advance rate-to-advance distance profile of the respective laser beam 1 and hence the processing, a constant advance rate over the distance is used here in order to apply a uniform or equally thick coating layer 80 in advance direction X on both surfaces 74.

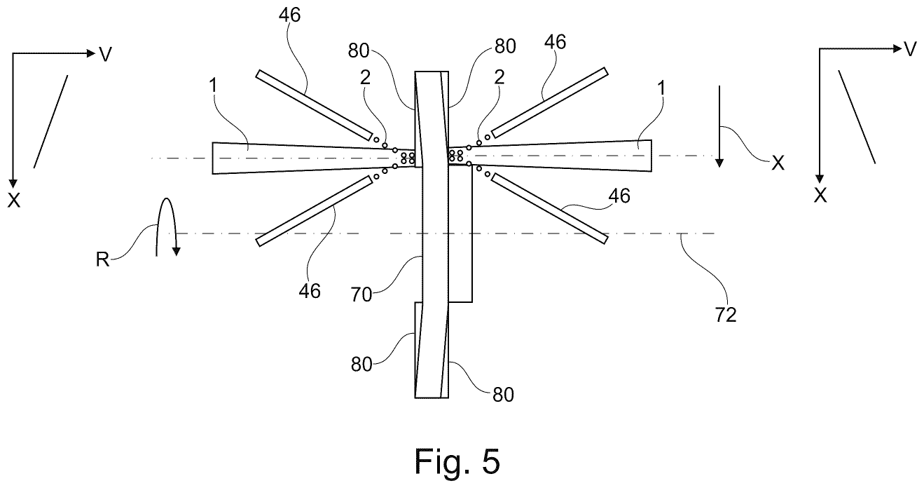

FIG. 5 differs in that thick coating layers 80 are applied inhomogeneously, specifically by means of mutually complementary advance rate-to-advance distance profiles. The left-hand laser beam 1 in FIG. 5 has an advance rate-to-advance distance profile that drops over the path traversed in advance direction X, while the right-hand laser beam 1 in FIG. 5 has an advance rate-to-advance distance profile that rises over the path traversed in advance direction X. By way of example, the slopes of the respective profiles are of the same magnitude. Thus, coating layers 80 that are visibly wedge-shaped in cross section are created, which have mutually opposite wedge-shaped alignments here. What is advantageous about the use of such advance rate-to-advance distance profiles is that doming of the component 70 that already exists or has been generated can be compensated for, as apparent from the geometry of the component 70 in FIG. 5, which is inclined to the left in its outer region in FIG. 5. Advantageously, the coating layer 80 can additionally be built up in multiple layers, i.e. in particular by repeated laser cladding, in order to form a coating layer 80 of maximum homogeneity in terms of its thickness, which has maximum service life in the working example of the brake disk for utilization.

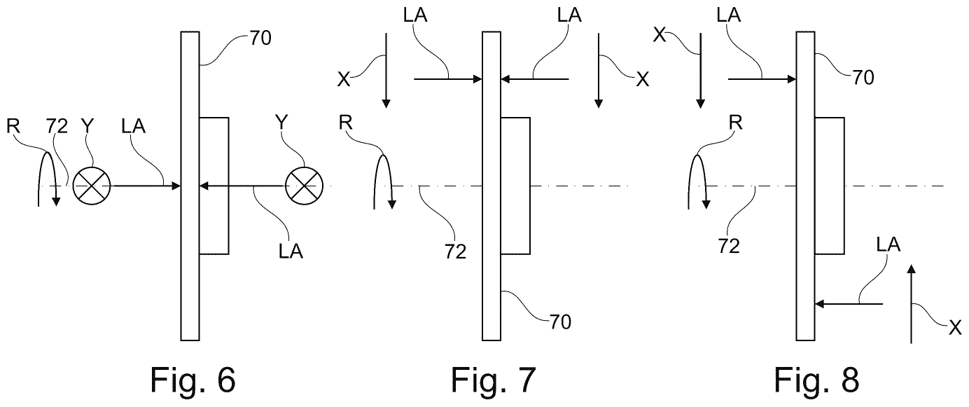

FIGS. 6 to 8 show different means of beam guidance of the laser beam 1 or of the working trajectory or of the associated process zone with the laser-filler material interaction zone 6 and hence for production of the coating layers 80. The laser beam axis LA shown shows the process zone or working site in each case, where the coating layer 80 is currently being produced, and can be provided by an appropriate arrangement of the processing head 20 relative to the surfaces 74.

In FIG. 6, the laser beam 1 advances in Y direction (see also FIG. 2). In FIG. 7, the laser beam 1 advances in X direction (see also FIG. 2). What is additionally common to FIGS. 6 and 7 is that the laser beam axes LA of the laser beams 1 each coincide. This means that the laser beam axes LA of the laser beams 1 are moved congruently to one another. This means that the coating layers 80 are produced on the surfaces 74 at respectively parallel sites. This improves the thermally symmetric processing of the component 70 and reduces the risk of doming of the component 70.

In FIG. 8, the coating layers 80, by contrast, are each produced on the surfaces 74 at sites that are offset in X direction. The laser beam axes LA of the laser beams 1 are moved here incongruently to one another, and are especially offset by a predefined lateral distance in X direction. This reduces the risk that the opposite processing heads 20 irradiate one another, in order to provide a safe apparatus 10 and a safe laser cladding method.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser cladding method comprising:
directing a filler material in a pulverulent form along a respective working trajectory onto each respective surface of two mutually opposite surfaces of a component, and
heating the filler material and the component by directing a respective laser beam along the respective working trajectory so that the filler material binds to the component as the filler material meets the respective surface, thereby producing coating layers on the two mutually opposite surfaces at least partly at a same time.

2. The laser cladding method as claimed in claim 1, wherein the working trajectory is in a spiral form.

3. The laser cladding method as claimed in claim 1, wherein a point of incidence of the respective laser beam on the respective surface is moved along the working trajectory with a relative speed of at least 20 m/min.

4. The laser cladding method as claimed in claim 1, wherein the component is in a rotationally symmetric form and is rotated about an axis of rotation during the production of the coating layers.

5. The laser cladding method as claimed in claim 1, wherein the filler material is in a powder form before being melted by the laser beam.

6. The laser cladding method as claimed in claim 1, wherein the filler material is directed onto each respective surface of the component via at least three injectors.

7. The laser cladding method as claimed in claim 6, wherein the injectors are in a form of tubes.

8. The laser cladding method as claimed in claim 6, wherein an exit angle of the injectors with respect to a normal to the respective surface of the component is less than 60°.

9. The laser cladding method as claimed in claim 1, wherein the filler material is directed to the respective surface via a conveying gas, and wherein the conveying gas has a relative atomic mass of at least 4 and/or a specific volume flow rate of at least 3.21 (STP)/min per mm² of a cross-sectional area.

10. The laser cladding method as claimed in claim 1, wherein the coating layers of the component are produced in a direction from a relative inside of the surfaces to a relative outside of the surfaces.

11. The laser cladding method as claimed in claim 1, wherein a laser beam axis of the respective laser beam is inclined at an angle of incidence in a range from greater than 0° to 35° relative to the respective surface.

12. The laser cladding method as claimed in claim 1, wherein a laser power output of a first laser beam directed onto a first surface of the two surfaces is at least twice as high as a laser power output of a second laser beam directed onto a second surface of the two surfaces.

13. The laser cladding method as claimed in claim 1, wherein the two laser beams directed at the two surfaces of the component respectively are collectively moved relative to the component by a common advancing unit.

14. The laser cladding method as claimed in claim 1, wherein the two laser beams directed at the two surfaces of the component respectively are moved with different advance rate-to-distance profiles, and/or different amounts of the filler material are fed to the two surfaces of the component, thereby creating different layer thicknesses of the coating layers on the two mutually opposite surfaces of the component.

15. The laser cladding method as claimed in claim 1, wherein the two laser beams directed to the two surfaces of the component respectively are moved with different advance rate-to-distance profiles, and wherein the different advance rate-to-advance distance profiles are mutually complementary.

16. A component with two mutually opposite surfaces that are coated with coating layers, wherein the coating layers are produced by a laser cladding method as claimed in claim 1.

17. An apparatus for execution of a laser cladding method as claimed in claim 1, wherein the apparatus comprises at least one laser for generating the laser beams, and at least one filler material conveyor for conveying of the filler material to the surfaces of the component.
